(19) United States
(12) Patent Application Publication
(10) Pub. No.: US 2002/0154244 A1
(43) Pub. Date: Oct. 24, 2002

(54) Moving images synchronization system

(75) Inventors: Kenichi Nakagawa, Kawasaki (JP); Keisuke Katada, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/108,339

(22) Filed: Mar. 29, 2002

(30) Foreign Application Priority Data
Apr. 24, 2001 (JP) 2001-126080

(51) Int. Cl. G06F 15/16; H04N 7/12; H04N 11/02; H04N 11/04; H04N 5/04; H04N 9/44; H04N 5/445

(52) U.S. Cl. 348/423.1; 348/500; 348/564; 709/219

(57) ABSTRACT

A relay server obtains web data including a motion picture from a WWW server, and embeds control code composed of a script or bytecode in the obtained web data to generate web data for synchronization. The control code is sent to each of clients, and becomes a controller to control the browser in the same client. When one of the clients sends manipulating information indicating manipulation of the motion picture such as playback, stop, etc. to the relay server, the same relay server receive the manipulating information, and broadcast it to all of the clients including the sender. The controller of each client receives the manipulating information, and executes playback, stop, etc. in synchronization.

### BACKGROUND OF THE INVENTION

1. Field of the Invention

The present invention relates to a moving images synchronization system which controls computers to display moving images such as video contents in synchronization with one another. The present disclosure relates to subject matter contained in Japanese Patent application No. 2001-126080 (filed on Apr. 24, 2001), which is expressly incorporated herein by reference in its entirety.

2. Description of the Related Art

An art is known which controls computers to display moving images in synchronization with something. For example, a system is operational which makes a computer display the same images displayed on a screen of another computer. This system comprises distributing and receiving computers. The distributing computer displays moving images on the screen, and scans the screen images to send them to the receiving computer. The receiving computer, by receiving the sent images, can display on its screen the same moving images which are displayed on the screen of the distributing computer. That is, among the plural computers the moving images are displayed in synchronization with each other.

However, for displaying the moving images among the computers in synchronization with one another, the computers should be connected one another via fast communications lines. Even though the fast connection is provided, unavoidable occurrence of a dropout, that is, momentary loss of the video signal, interferes the smooth display of the moving images.

### SUMMARY OF THE INVENTION

It is a primary object of the present invention to provide a moving images synchronization system which makes computers smoothly display moving images in synchronization with one another.

To accomplish the above object, according to one aspect of the present invention, the moving images synchronization program makes a server computer execute the following steps. These steps include a step of sending each of client computers web data including moving images, control code making the client computer display the moving images with reflecting manipulation on the same moving images, and control code making the client computer transmit manipulation on the moving images to said server computer; and a step of broadcasting, when the manipulation on the moving images is transmitted from one of said client computers, the same manipulation to all of said client computers.

With this configuration, after the moving images and web data including control code have been broadcasted to each client computer, the client computer displays the moving images in synchronization with one another according to the control code. The moving images synchronization program may be utilized for multimedia education, or for guidance at a museum with which a guide guides visitors.

### BRIEF DESCRIPTION OF THE DRAWINGS

The invention will be described below in detail with reference to the accompanying drawings, in which:

FIG. 1 is a diagram showing a system architecture in one embodiment of the present invention;

FIG. 2 is a schematic diagram showing a user table;

FIG. 3 is a flowchart showing a log-in process;

FIG. 4 is a schematic diagram showing a moving images synchronization process;

FIG. 5 is an explanatory diagram showing an example of an original web data;

FIG. 6 is an explanatory diagram showing an example of a web data for synchronizing display;

FIG. 7 is a diagram showing an example of a screen displayed by a browser in a client machine;

FIG. 8 is a diagram showing an example of a screen displayed by a browser in a client machine;

FIG. 9 is a schematic diagram showing a process for manipulating moving images;

FIG. 10 is a schematic diagram showing a protocol prescribed for moving images manipulating information;

FIG. 11 is a schematic diagram showing a process for updating a layout; and

FIG. 12 is a schematic diagram showing a protocol prescribed for layout information.

### DESCRIPTION OF THE PREFERRED EMBODIMENT

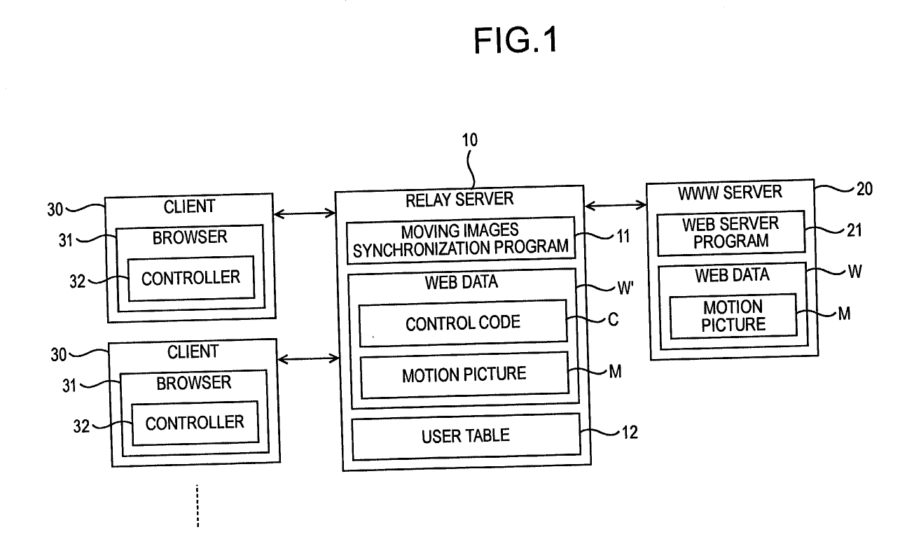

One embodiment of the present invention will hereinafter be described with reference to the accompanying drawings. FIG. 1 is a diagram showing a system architecture including a relay server machine 10 according to the embodiment. The relay server 10 is connected to a WWW server machine 20 via a network such as the Internet. Further, the relay server 10 is connectable to client machines 30 via the network.

The relay server 10, a server computer, has a storing device in which an operating system and a moving images synchronization program 11 are preinstalled. The moving images synchronization program 11 comprises a web server program module and a server-side program module.

The WWW serer 20 has a storing device in which an operating system and a web server program are preinstalled. Further, with the storing device of the WWW server 20, web data W is stored. The web data W includes data written in HTML or XHTML, and a motion picture M (moving images) encoded according to MPEG, AVI, RealMedia, flash animation or other formats for encoding.

The client machine 30, a client computer, is composed of a computer such as a personal computer. The client 30 has a storing device in which an operating system and a web browser program 31 are preinstalled. The user of the client 30, as described later, logs in to the relay server 10 from the client 30. After the log-in, the browser 31 in the client 30 receives control code composed of a script or bytecode from the relay server 10, and the control code becomes a controller 32 which controls the processes in the browser 31.

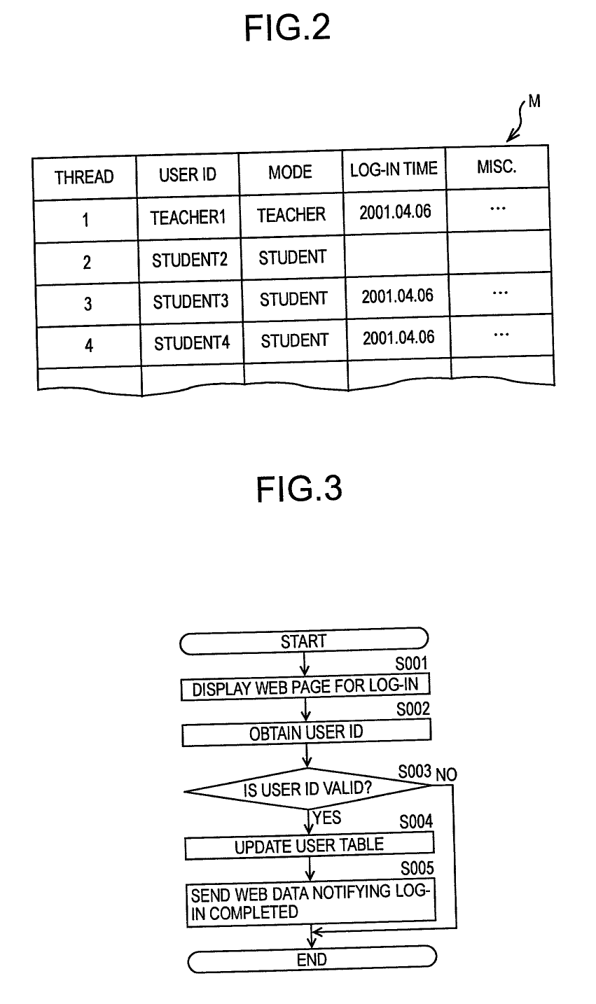

With the storing device of the relay server 10, a user table 12 is stored. FIG. 2 is a schematic diagram showing the user table 12, which has records corresponding to respective users registered previously. In the user table 12, each record has “USER ID,” “MODE,” “LOG-IN TIME,” and “MISC.” fields.

The “USER ID” field is stored with a user ID uniquely corresponding to one of users. As the user ID, the log-in name, the host name of the client 30, or the nickname of the user, can be used.

The “MODE” field is stored with information representing the authorization level assigned to the corresponding user. According to the example shown in FIG. 2, “TEACHER,” or “STUDENT” mode is assigned. The “MISC.” field is stored with the user's real name, an ID number, etc.

When one of the users logs in to the relay server 10 from the client 30, the log-in time is stored in the “LOG-IN TIME” field of the record in the user table 12 corresponding to the same user. Note that when the user logs in, the moving images synchronization program 11 assigns a thread corresponding to the same user.

The log-in process will be described below. FIG. 3 is a flowchart showing the log-in process in the relay server 10. After a user launches the browser 31 by operating the client 30, the browser 31 requests web data for log-in from the moving images synchronization program 11 in the relay server 10 to start the process as shown in FIG. 3.

At S001, the relay server 10 makes the client 30 display the web data for log-in as a web page. Then, the user enters the user ID into the displayed web page.

At the next step S002, the relay server 10 obtains the user ID entered by the user.

At the next step S003, the relay server 10 judges whether the entered user ID is valid or not. More specifically, the relay server 10 refers to the user table 12 to find the record whose “USER ID” field contains the user ID identical to that entered at S002. The relay server 10, if the record is found, advances the processing to S004. Whereas if not found, the relay server 10 terminates the processing.

At S004, the relay server 10 updates the user table 12. More specifically, the relay server 10 stores the present time in the “LOG-IN” field of the record whose user ID is identical to that obtained at S002, and assigns a thread corresponding to the user.

At S005, the relay server 10 sends the client 30 web data for notifying the fact that the log-in has successfully been completed. The sent web data contains control code for the initial processing which is composed of a script or an applet. In the control code, a parameter is set which represents the entity of the “MODE” field of the record in the user table 12 corresponding to the user. The client 30, when receives the web data for notifying, executes the control code. Note that the control code becomes the controller 32 to control the browser 31 by being executed on the same browser 31.

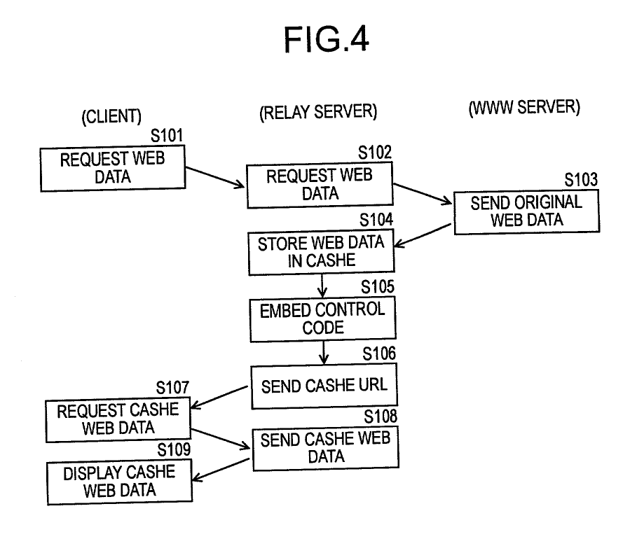

After the processing shown in FIG. 3, the client 30 of the user, who has logged in, requests the web data W containing the motion picture M from the relay server 10. Then, the relay server 10 starts the moving images synchronization process, which will hereinafter be described with reference to FIG. 4.

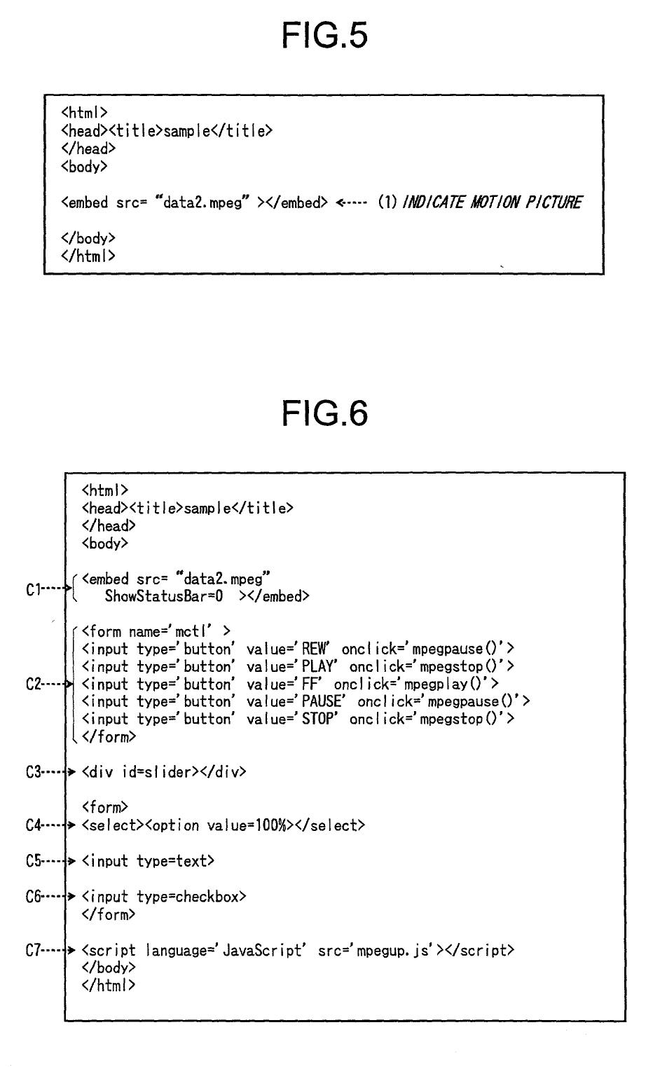

The client 30 requests the web data W containing the motion picture M from the relay server 10 (S101). Then, the relay server 10 requests the same web data W from the WWW server 20 (S102). In reply to the request, the WWW server 20 sends the web data W to the relay server 10 (S103). FIG. 5 is an explanatory diagram showing an example of the original web data W. Then, the relay server 10 receives the web data W to store it in cashe, a certain area reserved in the storing device (S104).

Further, the relay server 10 embeds the control code C for synchronization of motion pictures in the stored web data W to make web data W′ for synchronizing display (S105). FIG. 6 is an explanatory diagram showing an example of the web data W′ for synchronizing display. In FIG. 6, segments C1-C7 corresponds to the control code C. The control code C, for instance, comprises code written in HTML or XHTML, a script written in JavaScript, or bitecode of Java Applet.

Then, the relay server 10 sends a cashe URL, a URL indicating the web data W′, to the client 30 (S106). The client 30 receives the cashe URL, and requires the web data W′ by indicating the received cashe URL under control of the controller 32 (S107). In reply to the request, the relay server 10 sends the web data W′ to the client 30 (S108).

The client 30 receives the web data W′, and displays a web page generated based on the same web data W′ (S109). As described above, the web data W′ not only includes the motion picture M, but also the control code C embedded for moving images synchronization. Consequently, a function for moving images synchronization is added to the controller 32, by the control code C being executed in the browser 31 of the client 30.

As shown in FIG. 6, the web data W′ for moving images synchronization comprises the original web data W shown in FIG. 5, and the control code C embedded in the original web data W. The control code C comprises code segments C1-C7.

The code segment C1 is composed of a statement generated by “ShowStatusBar=0” being added to the portion (1) of the original web data W (FIG. 5) indicating the motion picture M. With the addition of “ShowStatusBar=0,” an operational component of a plug-in program which the designer of the original web data W designed for displaying the motion picture M, come to be hidden from view.

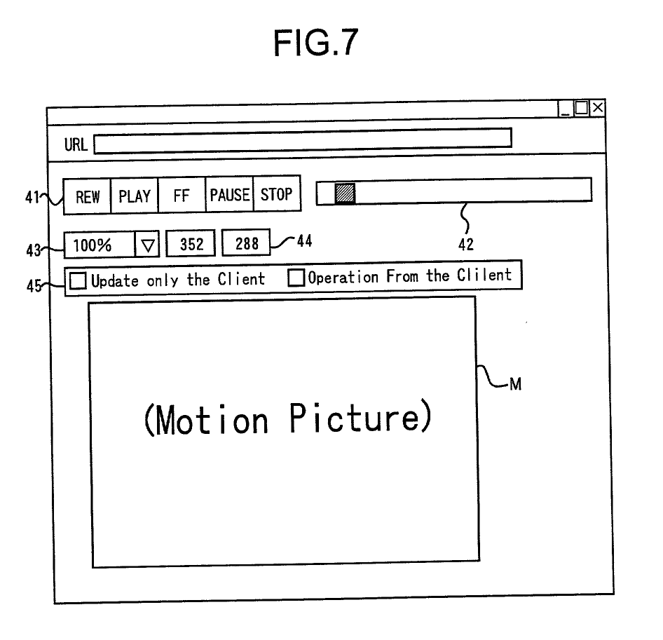

The code segment C2 relates to the processing for making the browser 31 display buttons indicating “REW”(rewind), “PLAY”(playback), “FF”(fast forward), “PAUSE,” and “STOP” of the motion picture M. Note that the buttons correspond to the first type operational component for displaying moving images. FIG. 7 is a diagram showing an example of a screen displayed by the browser 31 in a client 30. In FIG. 7 is shown an operational component 41 including the buttons indicating “REW,” “PLAY,” “FF,” “PAUSE,” and “STOP” on the screen.

The code segment C3 relates to the processing for making the browser 31 display an indicator 42, an operational component indicating the position of the frame in the motion picture M. The indicator 42 corresponds to the second type operational component for displaying moving images. Note that the position of the frame represents the relative position of the present frame in the frames contained in the motion picture M in time sequence. The indicator 42 has a rectangular slider able to slide across in FIG. 7. When the frame on view is that displayed immediately after the start of a playback of the motion picture M, the slider is located at the left end in the moving range. On the other hand, when the frame on view is that displayed immediately before the end of a playback of the motion picture M, the slider is located at the right end in the moving range.

The code segment C4 relates to the processing for making the browser 31 display a select box 43, an operational component for designating the display size (%) of the motion picture M. The code segment C5 relates to the processing for making the browser 31 display a text box 44, an operational component for designating the display size (width, height) of the motion picture M by numeric values.

The code segment C6 relates to the processing for making the browser 31 display a check box 45. This check box 45 is used for setting whether changes of the display layout of the client 30 are reflected only in the same client 30 or in the other clients 30. If the “Update Only the Client” is checked, the changes of layout are reflected only in the client 30 where the changes originally occur. On the other hand, if the “Operation from the Client” is checked, the changes of layout are reflected not only in the client 30 where the changes originally occur, but also in the other client 30.

The code segment C7 relates to the processing for changing layouts. The code segment C7, according to the example shown in FIG. 6, is written in JavaScript. The entity indicated by the code segment C7 is a script whose file name is “mpegup.js” for executing processes of designating the default position of the motion picture M, designating the default size of the motion picture M, changing the locations of the motion picture M, displaying the operational components, and changing the web data W′.

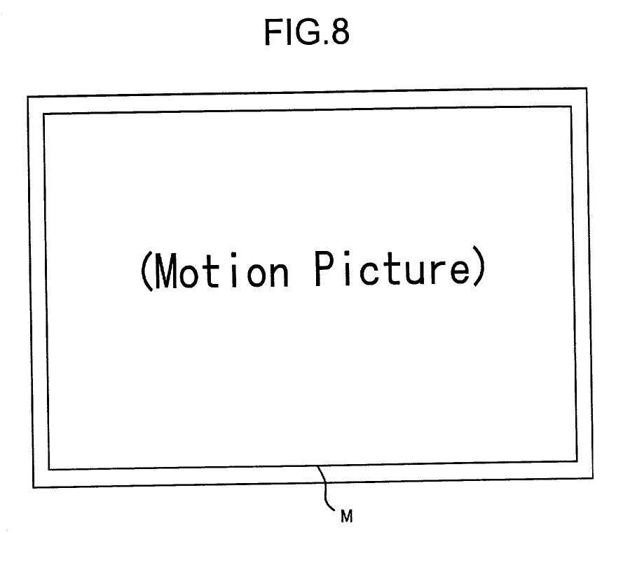

The controller 32 controls the browser 31 on the basis of the code segments C1-C7. Though the web data W′ sent to clients 30 are identical, the default screens, default layouts, of the clients 30 are different one another. More specifically, after the log-in process according to FIG. 3, the controller 32 of the each client 30 holds the entity of the “MODE” field in the user table 12 (FIG. 2). That is, the controller 32 of the each client 30 recognizes the mode of the user operating the same client 30 is whether “TEACHER” or “STUDENT.” As the processing for display at S109 in FIG. 4 is executed, the controller 32 makes browser 31 display the screen for a teacher shown in FIG. 7 if the mode is “TEACHER.” On the other hand, the controller 32 makes browser 31 display the screen for a student shown in FIG. 8 if the mode is “STUDENT.”

In the screen for a teacher (FIG. 7), are shown not only the motion picture M, but also the operational components 41-45. On the other hand, in the screen for a student (FIG. 8), is only shown the motion picture M in a full-screen mode. Provided that clients 30 display the respective default screens according to the modes of the users, the user whose mode is a teacher can start the moving images synchronization process. More specifically, when the “PLAY” button of the operational component 41 displayed in the screen for the teacher (FIG. 7) is clicked by a pointing device such as a mouse, the synchronizing display of the motion picture M starts. That is, every client 30 starts a playback of the motion picture M simultaneously.

When the “REW,” “PLAY,” “FF,” “PAUSE,” or “STOP” button is pressed in the operational component 41, every client 30 executes rewind, playback, fast-forward, pause, or stop of the motion picture M. When the slider of the indicator 42 is dragged across in FIG. 7, every client 30 simultaneously restarts a playback at the frame corresponding to the position of the slider of the indicator 42.

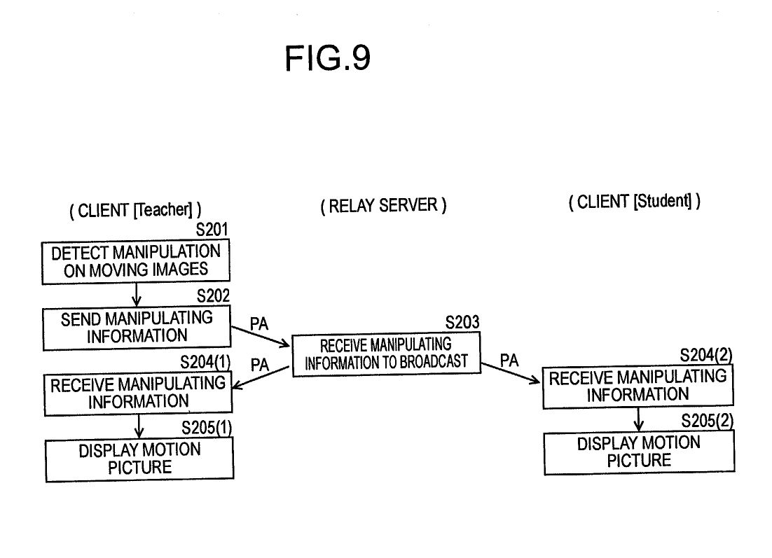

The processing when the operational component 41 or the indicator 42 is manipulated, will hereinafter be described with reference to FIG. 9. Note that the controller 32 of the teacher's client 30 continuously monitors generation of the events raised by the first type operation, a button of the operational component 41 being clicked, or the second type operation, the slider of the indicator 42 being dragged. When the controller 32 of the teacher's client 30 detects the event concerning manipulation of moving images (S201), generates manipulating information representing the detected event, and sends the manipulating information to the relay server 10 according to a protocol PA (S202).

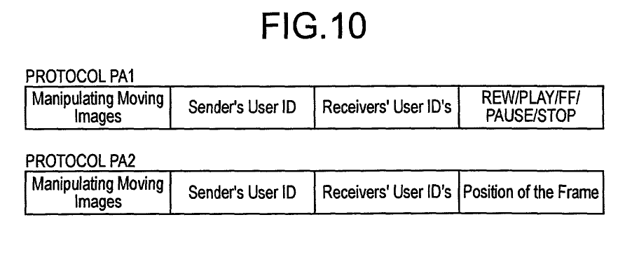

FIG. 10 is a schematic diagram showing the protocol PA prescribed for the manipulating information. The protocol PA is classified into a protocol PA1 corresponding to the first manipulating information, and a protocol PA2 corresponding to the second manipulating information. When a button in the operational component 41 is clicked, the manipulating information is sent according to the protocol PA1. When the slider of the indicator 42 is dragged, the manipulating information is sent according to the protocol PA2.

The protocol PA1 has the field indicating that the information to be sent is related to “Manipulating Moving Images,” and also has “Sender's User ID” field, “Receivers' User ID's” field, and a field representing the generated event, one of REW/PLAY/FF/PAUSE/STOP. The “Sender's User ID” field is stored with the user ID of the user (teacher) whose client 30 detected the event. The “Receivers' User ID's” field is stored with all user ID's including the sender's.

The protocol PA2 has “Manipulating Moving Images,” “Sender's User ID,” and “Receivers' User ID's” fields identical to the aforementioned protocol PA1. Further, the protocol PA2 has the “Position of the Frame” field indicating the position of the frame in the motion picture M. After manipulation of the indicator 42, the controller 32 of the teacher's client 30 detects the position of the frame in the motion picture M to set the value indicating the position of the frame in the “Position of the Frame” field.

When the manipulating information is sent according to the protocol PA, the relay server 10 receives the manipulating information to broadcast it to all the clients 30 according to the protocol PA (S203). Note that the manipulating information is also sent to the teacher's client 30 even though it is the sender of the same information.

The controller 32 of each client 30 receives the broadcasted manipulating information simultaneously (S204(1), S204(2)), and displays the motion picture M according to the received manipulating information (S205(1), S205(2)). For instance, with receiving the first manipulating information according to the protocol PA1, the controller 32 of the client 30 refers to the “REW/PLAY/FF/PAUSE/STOP” field of the manipulating information, and based on the field executes rewind, play, fast-forward, pause, or stop of the motion picture M. On the other hand, with receiving the second manipulating information according to the protocol PA2, the controller 32 of the client 30 refers to the “Position of the Frame” field of the manipulating information to specify the position of the frame, and starts a playback simultaneous with other clients 30 at the specified position of the frame.

As described above, all the clients 30 including the sender itself start manipulation of the motion pictures M simultaneously. The motion pictures M are, therefore, displayed in complete synchronization. That is, the relay server 10 makes every client 30 display smoothly desired motion picture contents provided by a WWW server 20 in real time and in synchronization. Note that the motion picture M is previously broadcasted to each client 30, then, displayed in synchronization. The display in synchronization is actualized by sending and receiving the manipulating information whose information content is far smaller than that of the motion picture M. Consequently, the display in synchronization is realized based on lines whose information-carrying capacity is relatively small, such as PHS (Personal Handy-Phone System) or ISDN (Integrated Services Digital Network).

In the aforementioned screen for a teacher shown in FIG. 7, is displayed the operational components concerning display layout, such as the select box 43, text box 44, and check box 45. The teacher operates these boxes 43-45 to change the layout of the motion picture M displayed by the client 30.

For example, with the selection of the relative value indicating the size of the view area of the motion picture M via select box 43, the size of the motion picture M in the client 30 is updated. With input of the width and height of the view area of the motion picture M via text box 44, the size of the motion picture M is updated. Note that if “Update Only the Client” of the check box 45 is checked, the update of the layout is reflected only in the client 30 to which manipulation is made. On the other hand, if “Operation from the Client” of the check box 45 is checked, the update of the layout is reflected in every client 30.

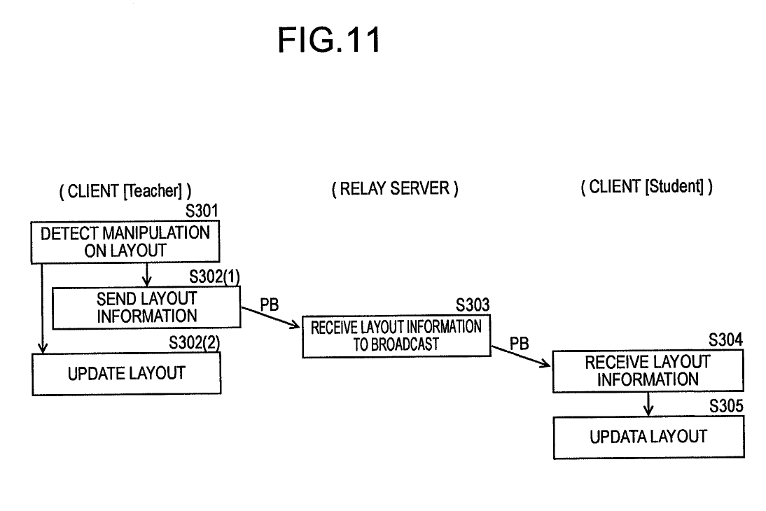

The processing will hereinafter be described when the manipulation on the layout is made and provided “Operation from the Client” of the check box 45 is checked, with reference to FIG. 11. Note that the controller 32 of the teacher's client 30 continuously monitors the generation of the event corresponding to the boxes 43-45. When the controller 32 of the teacher's client 30 detects the event indicating manipulation on layout via select box 43 or text box 44 (S301), generates layout information including the detected event to send it to the relay server 10 according to the protocol PB (S302(1)), and update coincidently the layout in the same client 30 itself (S302(2)).

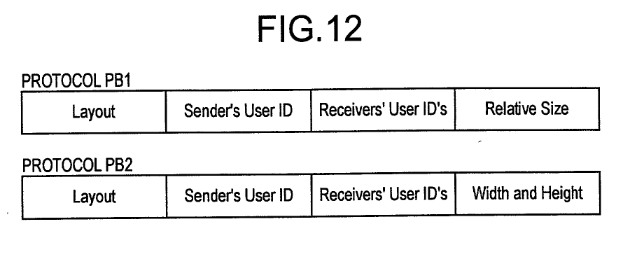

The layout information sent at S301(1) will further be described. FIG. 12 is a schematic diagram showing a protocol PB prescribed for the layout information. The protocol PB is classified into the protocol PB1 corresponding to designation of a relative size, and the protocol PB2 corresponding to designation of an absolute size. With designation of a relative size via select box 43, the layout information is sent according to the protocol PB1. With designation of a width and a height via text box 45, the layout information is sent according to the protocol PB2.

The protocol PB1 has the field indicating that the information to be sent is related to “Layout,” and also has “Sender's User ID,” “Receivers User ID's,” and “Relative Size” fields. The “Sender's User ID” field is stored with the user ID of the user (teacher) whose client 30 detected the event. The “Receivers' User ID's” field is stored with all the other users' user ID's. The “Relative Size” field is stored with the relative size of the motion picture M detected via select box 43.

The protocol PB2 has “Layout,” “Sender's User ID,” and “Receivers' User ID's” fields identical to the aforementioned protocol PB1. Further, the protocol PB2 has “Width and Height” field, which is stored with the width and the height of the motion picture M detected via text box 44.

When the layout information is sent according to the protocol PB, the relay server 10 receives the layout information to broadcast it to all the clients 30 except the sender according to the protocol PB (S303). That is, the relay server 10 broadcasts the layout information to the clients 30 of the users whom “Receivers' User ID's” of the layout information indicates. Note that the layout information is not sent to the sender, the teacher's client 30.

The controller 32 of each student's client 30 receives the broadcasted layout information (S304), and updates the display layout of the motion picture M according to the received layout information (S305). For instance, with receiving the layout information according to the protocol PB1, the controller 32 of client 30 updates the view area of the motion picture M so as to coincide with the area indicated by “Relative Size” of the layout information. With receiving the layout information according to the protocol PB2, the controller 32 of client 30 updates the view area of the motion picture M so as to coincide with the area indicated by “Width and Height” of the layout information.

As described above, the layout of the students' clients 30 are updated based on the broadcasted layout information. Note that the layout of the teacher's client 30 has already updated based on the manipulation detected in the same client 30 (S302(2)) Consequently, the update of the layout is reflected in every client 30. According to the above description, the “Receiver's User ID” field of the layout information is stored with all user ID's except the teacher as a sender. In contrast to that, if the “Receiver's user ID” is stored with only specified users' user ID's, the update of the layout is reflected only in the specified users' clients 30. Further, according to the above description, the update of the layout is concerned with a size. Without restriction to the example, the update of the layout may be concerned with a location, a form, and zoom in/out.

According to the moving images synchronization system of the present invention that have the architectures described above, on each client computer, moving images are smoothly displayed in real time and in synchronization with another.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A program product comprising a moving images synchronization program, said moving images synchronization program controlling a server computer, connectable to client computers each executing a web browser, to execute:
a step of sending each of said client computers web data including moving images, control code making the client computer display the moving images with reflecting manipulation on the same moving images, and control code making the client computer transmit manipulation on the moving images to said server computer; and
a step of broadcasting, when the manipulation on the moving images is transmitted from one of said client computers, the same manipulation to all of said client computers.

2. The program product according to claim 1, said control code included in said web data making said client computer generate, when a first manipulation selected from a group of playback, stop, pause, fast-forward, and rewind of the moving images is made at the same client computer, a first manipulating information indicating the first manipulation, and send it to said server computer to make the same server computer broadcast the first manipulating information to all of said client computers to make each of said client computers display the moving images with reflecting the first manipulation indicated by the first manipulating information in synchronization with those on the sending client computer.

3. The program product according to claim 1, said control code included in said web data making said client computer generate, when a second manipulation designating a start position of a frame to be played back is made at the same client computer, a second manipulating information indicating the second manipulation, and send it to said server computer to make the same server computer broadcast the second manipulating information to all of said client computers to make each of said client computers display the moving images with reflecting the second manipulation indicated by the second manipulating information in synchronization with those on the sending client computer.

4. The program product according to claim 1, said control code included in said web data making said client computer generate, when a third manipulation designating the moving images' layout is made at the same client computer, a third manipulating information indicating the third manipulation, and send it to said server computer to make the same server computer transmit the third manipulating information to those selected from said client computers to make each of the selected client computers display the moving images with the third manipulation indicated by the third manipulating information.

5. The program product according to claim 1, said control code included in said web data making said client computer display the moving images with a default layout prescribed with respect to a user of the same client computer.

6. A moving images synchronization method actualized by a server computer connectable to client computers each executing a web browser, comprising:
a step of sending each of said client computers web data including moving images, control code making the client computer display the moving images with reflecting manipulation on the same moving images, and control code making the client computer transmit manipulation on the moving images to said server computer; and
a step of broadcasting, when the manipulation on the moving images is transmitted from one of said client computers, the same manipulation to all of said client computers.

7. The method according to claim 6, said control code included in said web data making said client computer generate, when a first manipulation selected from a group of playback, stop, pause, fast-forward, and rewind of the moving images is made at the same client computer, a first manipulating information indicating the first manipulation, and send it to said server computer to make the same server computer broadcast the first manipulating information to all of said client computers to make each of said client computers display the moving images with reflecting the first manipulation indicated by the first manipulating information in synchronization with those on the sending client computer.

8. The method according to claim 6, said control code included in said web data making said client computer generate, when a second manipulation designating a start position of a frame to be played back is made at the same client computer, a second manipulating information indicating the second manipulation, and send it to said server computer to make the same server computer broadcast the second manipulating information to all of said client computers to make each of said client computers display the moving images with reflecting the second manipulation indicated by the second manipulating information in synchronization with those on the sending client computer.

9. The method according to claim 6, said control code included in said web data making said client computer generate, when a third manipulation designating the moving images' layout is made at the same client computer, a third manipulating information indicating the third manipulation, and send it to said server computer to make the same server computer transmit the third manipulating information to those selected from said client computers to make each of the selected client computers display the moving images with the third manipulation indicated by the third manipulating information.

10. The method according to claim 6, said control code included in said web data making said client computer display the moving images with a default layout prescribed with respect to a user of the same client computer.

11. A moving images synchronization system, comprising:
a server computer connectable to client computers each executing a web browser; and
a moving images synchronization program stored with a storing device, said moving images synchronization program controlling said server computer to execute:
a step of sending each of said client computers web data including moving images, control code making the client computer display the moving images with reflecting manipulation on the same moving images, and control code making the client computer transmit manipulation on the moving images to said server computer, and
a step of broadcasting, when the manipulation on the moving images is transmitted from one of said client computers, the same manipulation to all of said client computers.

12. The system according to claim 11, said control code included in said web data making said client computer generate, when a first manipulation selected from a group of playback, stop, pause, fast-forward, and rewind of the moving images is made at the same client computer, a first manipulating information indicating the first manipulation, and send it to said server computer to make the same server computer broadcast the first manipulating information to all of said client computers to make each of said client computers display the moving images with reflecting the first manipulation indicated by the first manipulating information in synchronization with those on the sending client computer.

13. The system according to claim 11, said control code included in said web data making said client computer generate, when a second manipulation designating a position of a start frame to be played back is made at the same client computer, a second manipulating information indicating the second manipulation, and send it to said server computer to make the same server computer broadcast the second manipulating information to all of said client computers to make each of said client computers display the moving images with reflecting the second manipulation indicated by the second manipulating information in synchronization with those on the sending client computer.

14. The system according to claim 11, said control code included in said web data making said client computer generate, when a third manipulation designating the moving images' layout is made at the same client computer, a third manipulating information indicating the third manipulation, and send it to said server computer to make the same server computer transmit the third manipulating information to those selected from said client computers to make each of the selected client computers display the moving images with the third manipulation indicated by the third manipulating information.

15. The system according to claim 11, said control code included in said web data making said client computer display the moving images with a default layout prescribed with respect to a user of the same client computer.
